(19) United States
(12) Patent Application Publication
(10) Pub. No.: US 2019/0120213 A1
(43) Pub. Date: Apr. 25, 2019

(54) Amalthea venturi thermal cycle

(71) Applicant: Mark Anthony Pederson, Kansas City, MO (US)

(72) Inventor: Mark Anthony Pederson, Kansas City, MO (US)

(21) Appl. No.: 15/793,644

(22) Filed: Oct. 25, 2017

(51) Int. Cl. F03G 7/06

(52) U.S. Cl. CPC F03G 7/06

(57) ABSTRACT

A method for converting thermal energy into kinetic energy comprising a venturi wherein an external warm gas through an intake undergoes convergent-flow adiabatic expansion to produce kinetic energy with a temperature drop, and then distinctively uses divergent-flow polytropic compression with cooling resulting in an exhaust temperature cooler than intake, providing a net kinetic energy output from the sustaining venturi exhaust.

### CROSS REFERENCE TO RELATED APPLICATIONS. (“PRIOR ART KNOWN TO THOSE SKILLED IN THE ART”)

Provisional Patent application No. 62/412,877 (filed Oct. 26, 2016)

U.S. Patent Classifications: 60 Power Plants/641.1 Utilizing Natural Heat; 60/641.6 With natural temperature differential; 60/641.7 Ocean Thermal Energy Conversion (OTEC); 60/325 Pressure Fluid Source and Motor;

| Related patent numbers/Title | Date |
|---|---|
| 5,083,429 Method of and compression tube for increasing pressure | 1992 |
| of a flowing gaseous medium, and power machine applying the | |
| compression tube . . . (Scarily similar, but referenced supersonic | |
| flows internally as integral, and subsonic flow elsewhere. Amalthea | |
| avoids Mach due to viscosity losses.) | |
| 9,752,549, Apparatus for Conversion of Energy from Fluid Flow | 2017 |
| (venturi-constricted incompressible water flow through impellers) | |
| 9,670,899, Low-profile power-generating wind turbine | 2017 |
| (venturi shroud for vertical turbine) | |
| 9,605,652, Apparatus and Method for Wind Compression | 2017 |
| (venturi shroud for turbine) | |
| 9,574,494, Dipole triboelectric injector nozzle | 2017 |
| (relates to gasoline engine fuel atomization) | |
| (venturi shroud for vertical turbine) | |
| 9,567,856, Apparatus for Extraction of Energy from a Fluid Flow | 2017 |
| (venturi suction drives generator) | |
| 7,010,920 Low temperature heat engine | 2006 |
| (no cold reservoir, breaks 2^{nd} Law of Thermodynamics, closed | |
| cycle.) | |
| 5,586,442, Thermal Absorption Compression Cycle | 1996 |
| (Basically an eductor/ejector) refers to classes 62 and 417. | |
| 4,430,861 Open cycle OTEC plant | 1984 |
| (Not applicable. An open Rankine cycle, flash evaporation of warm | |
| water in steam.) | |

### STATEMENT OF FEDERALLY SPONSORED RESEARCH OR DEVELOPMENT

No federally sponsored research or development at this time. Am applying for a Department of Energy ARPAe grant at this time, FOA 0001428, but will not know the results for at least 2-6 months.

### THE NAMES OF THE PARTIES TO A JOINT RESEARCH AGREEMENT

There are no parties to a joint research agreement as a result of research activities.

### REFERENCE TO A “SEQUENCE LISTING,” A TABLE, OR A COMPUTER PROGRAM LISTING APPENDIX

There are no Sequence Listing, Table, or Computer Program Listing to be submitted.

### BACKGROUND OF THE INVENTION

Heat engines like the Rankine steam engine typically convert thermal energy into mechanical motion energy (kinetic energy), and thereafter into electrical energy, if desired. Heat from a hot reservoir Qₕₒₜ goes through the heat engine and discharges a lesser amount of heat Q_{cold} to a colder reservoir. This is covered under the Second Law of Thermodynamics. The difference between Qₕₒₜ and Q_{cold} is the mechanical energy output.

From Carnot's Law the maximum theoretical efficiency

$$η = \frac{{Q}_{hot} - {Q}_{cold}}{{Q}_{hot}} = \frac{{T}_{hot} - {T}_{cold}}{{T}_{hot}} , \qquad ( 1 )$$

is an unattainable maximum theoretical thermal efficiency that all practical thermal engines strive towards. In an effort to increase energy efficiency in an era of higher energy costs, the discharged heat Q_{cold} is being scavenged to produce small amounts of recoverable energy by using colder ambient temperatures T_{ambient} as the next lower temperature where T_{ambient}<T_{cold}<Tₕₒₜ by stacking another heat engine after the first heat engine. The first heat engine is known as the topping cycle converting a majority of the energy from the hot thermal reservoir into mechanical energy. The trailing heat engine(s) is(are) known as a bottoming cycle(s) producing only small additional amounts of mechanical energy. The heat sent to the cold reservoir is the increase in entropy. An example would be the high-pressure, non-condensing steam turbine as the topping cycle, and the low-pressure, condensing steam turbine as the bottoming cycle.

Low-temperature waste heat Q_{cold} from power plants, steel mill cooling water, geothermal hot wells, and ocean tropical water is plentiful (and wasted) and efforts are being made to capture it with better bottoming cycles. Other than the low-pressure condensing steam turbine, the next best known bottoming cycle examples are the ammonia Rankine cycle (Kalina, Uehara cycle) and the Inverted Brayton cycle and are suited for near-ambient temperature differentials.

The Amalthea venturi thermal cycle, hereinafter known as the Invention, is a heat engine with closest similarity to an Inverted Brayton cycle but has no moving parts, without piston reciprocation or turbine rotation. It produces a kinetic gas flow.

Industrial Applicability: The Invention was originally designed for ocean thermal energy conversion (OTEC), but has applicability to other low-temperature differential energy scavenging operations such as condensing steam turbine replacement; as an augmentation to the Brayton cycle gas turbine exhaust in lieu of adding an Inverted Brayton cycle (“Double Brayton cycle”); anywhere a Kalina cycle (U.S. Pat. No. 4,489,563A, 1982) or similar thermal cycle (Uehara, JP2005291112A, 2004) are used; and for geothermal hot steam wells in lieu of a condensing turbine.

### BRIEF SUMMARY OF THE INVENTION

The Inverted Brayton cycle uses a compressible gas, usually air, as the working fluid, and has a low-pressure core relative to the intake and exhaust gas pressure. The Invention uses a common venturi where the venturi throat has a lower gas pressure than either the intake or exhaust when gas flows through the venturi. There are modifications to the venturi to make it a thermal engine. Advantages over Prior Art: Since there are no moving parts, there are less viscous losses and thus higher efficiency compared to a working fluid swirling around counter-rotating stator and rotor turbine blades, and there is no turbine blade leading-edge steam condensation impingement erosion upon the condensing turbine blade since the working fluid and any condensate flow parallel to the venturi walls.

### BRIEF DESCRIPTION OF THE SEVERAL VIEWS OF THE DRAWING

FIG. 1 is the Amalthea venturi thermal cycle cross-section. Full symmetrical venturi version. A rectangular cross-section (into the page, perpendicular to flow) is preferred.

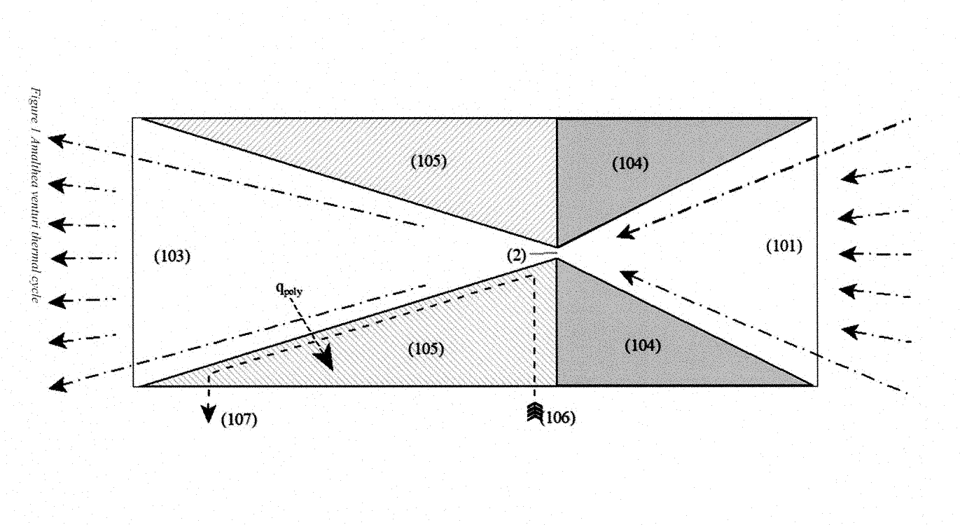

(101) Convergent adiabatic expander. Intake gas at temperature Tₐ and pressure pₐ.

(102) Modified-venturi throat, minimum cross-section. Gas temperature T_{b} and pressure p_{b}.

(103) Divergent polytropic compressor. Exhaust gas at temperature T_{c}<Tₐ and pressure pₐ≥pₐ.

(104) Thermally-insulative expander cross-section profile.

(105) Thermally-conductive compressor cross-section profile.

(106) Coolant input at T_{b}. Only shown for one side.

(107) Coolant output at T_{c}. Only shown for one side.

### DETAILED DESCRIPTION OF THE INVENTION

The Invention uses a venturi described herein to affect the conversion of thermal energy into kinetic energy.

A venturi intake convergent nozzle (1) drops the pressure through normal adiabatic expansion and converts heat (enthalpy) into a low-pressure, high-velocity gas stream at the venturi throat (2). The venturi exhaust divergent nozzle (3) compresses the low-pressure, high-velocity gas stream back into a higher-pressure, low-velocity stream and would normally exhaust at the same temperature and enthalpy as originally started. However, if cooling (6) to (7) is applied to the venturi exhaust divergent nozzle (5), cooling the gas compression, the compression becomes polytropic and costs less kinetic energy. The kinetic energy from adiabatic expansion upstream is now greater than the compression work absorbed downstream resulting in a net kinetic energy output. Thermal energy has been converted into a kinetic energy demonstrated as a sustaining flow of gas through the venturi. The heat input reservoir Qₕₒₜ comes from the warm gas entering the venturi intake. The cold reservoir heat removed Q_{cold} (q_{poly} in diagram) is the cooling applied to the venturi divergent exhaust nozzle.

By comparison, an Inverted Brayton cycle has adiabatic temperature and pressure reduction by turbine expander (power output) up front, isobaric cooling in the low-pressure middle, then adiabatic temperature and pressure rise by turbine compression back to atmospheric (power input) at a slightly smaller output temperature T_{c}. This occurs on a single turbine shaft. The Invention distinctly uses polytropic cooling during polytropic compression which almost doubles the net work possible from an Inverted Brayton cycle.

The polytropic open-flow work equation (derived from pvⁿ=constant) is,

$$w = \frac{n}{n - 1} R Δ T \qquad ( 2 )$$

where w is the work, n is the polytropic index (isothermal 1≤n≤γ adiabatic), γ is the gas-specific heat capacity index ratio (γ=1.4 for air), R is the specific gas constant from the Ideal Gas Law (287.145 J/kg/K for dry air, ˜290 J/kg/K for humid air), and ΔT is the change in temperature during expansion or compression.

Assume the intake temperature is Tₐ, the throat temperature is T_{b}, and the exhaust temperature is T_{c}, and ΔT_{bc}≡T_{c}-T_{b}<Tₐ-T_{b}≡ΔT_{ab}. Assume the polytropic index n during expansion is n_{ab}, and during compression with cooling is 1<n_{bc}<n_{ab}. Then,

$${p}_{poly} = {{p}_{i} ( \frac{T}{{T}_{i}} )}^{\frac{n}{n - 1}} , {q}_{poly} = ( \frac{γ - {n}_{bc}}{( γ - 1 ) ( {n}_{bc} - 1 )} ) R Δ {T}_{bc} \qquad ( 3 )$$

where pᵢ is the initial pressure, p_{poly} is the pressure after the polytropic process, q_{poly} will be the heat required to be moved during a polytropic process and is equal to the latent heat of condensation (Δm·L) during pseudo-adiabatic expansion of humid air. Absolute vapor pressures for humidity at Tₐ and T_{b} will determine what change in humidity mass Δm, and a modified Clausius-Clapeyron equation determines the latent heat L of condensation/evaporation,

$$latent heat of humidity L ( {p}_{wa} , {p}_{wb} , {T}_{a} , {T}_{b} ) = {R}_{w} \frac{{T}_{a} {T}_{b}}{( {T}_{a} - {T}_{b} )} ln ( \frac{{p}_{wb}}{{p}_{wa}} ) \\ {q}_{poly} = Δ m ( {T}_{a} , {T}_{b} ) L ( {p}_{wa} , {p}_{wb} , {T}_{a} , {T}_{b} ) \qquad ( 4 )$$

These will determine the pseudo-adiabatic expansion index n_{ab}. R_{w} is the specific gas constant for water vapor (461.53 J/kg/K); p_{wb} is the vapor pressure of water at temperature T_{b}; p_{wa} is the vapor pressure of water at temperature Tₐ. If there is no phase change during expansion, i.e. no humidity condensation with dry air, then the index n for expansion is the normal heat capacity ratio γ for air. The phase change for illustrative purposes was assumed to be water/humidity but could be any other vapor-to-liquid phase change gas like mercury, sodium, halogenated hydrocarbons, or ammonia. An open-cycle versus a closed thermal cycle uses one less heat exchanger (less cost) but would require an environmentally safe working fluid such as air.

The particular venturi design is not specific. The preferred embodiment has a rectangular-throated venturi to minimize rotational throat swirl, and therefore losses, from rotational momentum conservation that affects circular-throated venturi. A half-venturi should work as well as a full-venturi. Other venturi geometries are possible such as star, and ovoid.

From the mass continuity equation (ρ ·u·A=constant mass flow \dot{m}) through the venturi, a preferred embodiment venturi cross-section profile y=m|x|+½β (cross-section perpendicular to flow axis for a full venturi) should be chosen to help minimize viscous losses, x=0 at the throat, β is the minimum throat cross-section ratio. Viscous losses from high velocities in the throat can be large enough to stop net energy production.

$$β = \frac{{y}_{b}}{{y}_{a}} = {( 1 + \frac{2 R}{{u}_{a}^{2}} \cdot \frac{{n}_{ab}}{{n}_{ab} - 1} \cdot Δ {T}_{ab} )}^{- 0.5} \cdot {( \frac{{T}_{b}}{{T}_{a}} )}^{- \frac{1}{{n}_{ab} - 1}} \qquad ( 5 )$$

where β is the lineary-intercept, minimum throat cross-section ratio, uₐ is the initial intake velocity, yₐ is the venturi mouth cross-section, y_{b} is the venturi throat cross-section, R is the specific gas constant for the working fluid, n_{ab} is the expansion index, and ΔT_{ab}=Tₐ-T_{b}. This results in a cross-section profile ratio

$$\frac{1}{β} = \frac{{y}_{a}}{{y}_{b}} ∝ Δ {T}^{( \frac{1}{γ - 1} ) - \frac{1}{2}} \approx Δ {T}^{2} ( air ) ∴ Δ T ( y ) ∝ {y}^{- 0.5} \qquad ( 6 )$$

The goal is to minimize viscosity which is approximately a function of velocity squared, and velocity u is proportional to the square root of ΔT. Assume a turbulent Kármán-Prandtl friction loss factor f_{D} for ‘smooth pipe’, make some worst-case scenario simplifications, then

$${f}_{D} \approx \frac{1}{{( 1.930 log ( \frac{Re}{1.90} ) )}^{2}} = \frac{1}{{( 1.930 log ( \frac{ρ ( Δ T ( y ( x ) ) ) \cdot u ( Δ T ( y ( x ) ) ) \cdot y ( x )}{1.90 μ} ) )}^{2}} \qquad ( 7 )$$

Then the viscous losses Δw_{visc} are

$$Δ {w}_{visc} ≡ {\int }_{{x}_{a}}^{{x}_{c}} \frac{1}{2} {u}_{x}^{2} \cdot {f}_{D} \frac{dx}{{D}_{H}} \approx {\int }_{{x}_{a}}^{{x}_{c}} \frac{1}{2} {y ( x )}^{- 0.5} \cdot \frac{1}{( 1.930 {log ( ρ ( x ) u ( x ) y ( x ) )}^{2}} \frac{dx}{y ( x )} \qquad ( 8 )$$

where D_{H} is the hydraulic diameter, assumed to be D_{H} ∝y for a rectangular venturi, the gas density

$$ρ ( x ) = {( 1 - \frac{Δ T ( x )}{{T}_{0}} )}^{\frac{1}{n - 1}} , \qquad ( 9 )$$

velocity

$$u ( x ) = \sqrt{{u}_{0}^{2} + 2 R ( \frac{n}{n - 1} ) Δ T ( x )} , \qquad ( 10 )$$

absolute viscosity μ assumed to be constant 1.86e-5 Pa·s, and Reynolds number

$$Re = \frac{ρ uA}{μ} .$$

From (8) it is derived that the area nearest the high velocity throat is the largest contributor to viscosity losses, and a conclusion is drawn that a linear y(x) cross-section profile is preferred. Also, since the throat velocity must exist below the speed of sound to avoid shock wave losses and sonically-choked flow then

$${u}_{b}^{2} = {u}_{a}^{2} + 2 R ( \frac{γ}{γ - 1} ) ( {T}_{a} - {T}_{b} ) < {M}^{2} ≡ γ RT ∴ {T}_{a} < \frac{γ + 1}{2} {T}_{b} \qquad ( 11 )$$

where uₐ is the intake velocity and assumed uₐ<<u_{b}, u_{b} is the throat velocity, R is the specific gas constant, Tₐ is the intake temperature (K), T_{b} is the throat temperature after expansion, M is the speed of sound (Mach), and γ is the heat capacity ratio of the gas. Equation (8) is for dry gas adiabatic expansion to avoid choked flow.

Pseudo-adiabatic expansion (e.g. humidity condensation within air) allows a larger ΔT=Tₐ-T_{b} before choked flow, derived as

$${T}_{a} = ( \frac{γ + 1}{2} + \frac{Δ m L}{{m}_{gas} {c}_{p , gas} Δ T} ) {T}_{b} \qquad ( 12 )$$

where Δm is the condensate mass, m_{gas} is the non-condensing gas mass, c_{p,gas} is the non-condensing gas heat capacity, and ΔT_{ab}=Tₐ-T_{b} is the change in temperature of the non-condensing gas. It is an interative solution. There are too many upper temperature solutions depending initial conditions, but generally, a condensable gas greatly increases the upper intake temperature without hitting the adiabatic choke point in the venturi throat.

The invention claimed is:

1. An apparatus comprising:
(a) a convergent venturi intake section for adiabatic expansion using insulative venturi wall material;
(b) a minimal gap venturi throat section for subsonic flow; and
(c) a divergent venturi exhaust section with cooling through the conductive wall surfaces.
(d) having qualities comprising:
(i) a preferred embodiment of the venturi having a rectangular area yz-plane cross-section perpendicular to the flow along the x-axis, and the z-axis is a size-scalable constant z₀;
(ii) a linear cross-section profile, y=m|x|+½ β for a full-venturi, where y is the perpendicular cross-section to the flow x-axis, x is the axial position, x=0 at the venturi throat, m=tan(θ), θₐ is the approach angle of the convergent venturi intake section, θ_{c} is the approach angle of the divergent venturi exhaust section, and z₀>yₐ venturi intake cross-section; This is derived from the mass continuity equation and minimizing the high-velocity flow distances so as to minimize turbulence losses;
(iii) the approach angle θₐ of the convergent venturi intake section having a preferred embodiment of 30° or less, and the approach angle θ_{c} of the divergent venturi exhaust section with a preferred embodiment of 7° or less (common);
(iv) a throat-to-intake cross-section ratio (a common venturi comparison metric)
$$β = \frac{{y}_{b}}{{y}_{a}} = {( 1 - \frac{Δ T}{{T}_{a}} )}^{- \frac{1}{γ - a}} {( {u}_{a}^{2} - 2 R \cdot ( \frac{γ}{γ - 1} ) Δ T )}^{- 0.5} \qquad ( 13 )$$
typically below 5%, where yₐ is the venturi intake cross-section, y_{b} is the venturi throat cross-section, Tₐ is the venturi intake and warm reservoir temperature (K), T_{b} is the venturi throat and the cold reservoir temperature (K), ΔT=Tₐ-T_{b}, uₐ is the venturi intake velocity, R is the specific gas constant for the compressible gas being used,
$$γ = \frac{{c}_{p}}{{c}_{υ}}$$
is the ratio of the heat capacities of the compressible gas being used, this being derived from the mass continuity, open flow work, and energy conservation equations;
(v) a thin, smooth dielectric coating on the inside of the venturi gas flow surfaces to enhance passive triboelectrification between the flowing gas and venturi, and thereby enhancing electrostatic turbulence reduction;
(vi) A divergent venturi exhaust section with a much higher heat conductivity than the gas notwithstanding the dielectric coating in previous part (d)(v), a preferred embodiment of ≥100 times the heat capacity of the gas to ensure intended polytropic cooling;
(vii) A divergent venturi exhaust section length equal to the thermal entry length to ensure maximum intended polytropic cooling, typically
$$L = \frac{{y}_{b}}{tan ( {θ}_{c} )}$$
(viii) Allowing the heat carrier fluid from the cold reservoir to flow parallel the temperature gradient inside the venturi, coolest near the venturi throat, flowing past the thermally-conductive divergent venturi exhaust section wall material interfacing with the flowing gas inside the venturi, thereby having a temperature profile similar to a counter-current heat exchanger and maximizing the polytropic heat transfer.

2. A system transforming thermal energy into kinetic energy using a venturi comprising:
(a) expanding a gas by adiabatic expansion in a convergent venturi intake section;
(b) passing through a subsonic venturi throat section not critically choked; most gas venturi metering systems are critically choked; and
(c) distinctively, polytropically compressing with cooling in the divergent venturi section thereby decreasing the compression work to less than the expansion work, resulting in net kinetic energy;
(d) using the excess kinetic energy to further pressurize above original pressure in steady flow, or allow kinetic energy to accelerate the intake velocity;
(e) utilizing the pressure differential over the exhaust area (Pressure×Area×Velocity=Power), a preferred embodiment being electrostatic induction (electrohydrodynamics), or disadvantageously, a bladed windmill or turbine.

3. A process transforming thermal energy into kinetic energy using a venturi comprising the steps of:
(a) Converting enthalpy of a compressible gas into the kinetic energy of a high-speed gas via a convergent venturi intake section and through a subsonic venturi throat section; and
(b) Converting kinetic energy of part (a) back into enthalpy by stagnation compression in a divergent venturi section restoring original pressure; and
(c) Reducing the compression work absorbed of part (b) by using polytropic compression with cooling, making the kinetic energy generated in part (a) more than the kinetic energy absorbed in part (b).
